(19) United States
(12) Patent Application Publication
(10) Pub. No.: US 2023/0291069 A1
(43) Pub. Date: Sep. 14, 2023

(54) FLAME QUENCHING CHAMBER FOR STATIONARY BATTERY

(71) Applicant: Rivian IP Holdings, LLC, Irvine, CA (US)

(72) Inventors: Akshay Murkute, Irvine, CA (US); Khaled Bahei-Eldin, Irvine, CA (US); Ming Ma, Tustin, CA (US)

(21) Appl. No.: 17/690,372

(22) Filed: Mar. 9, 2022

(51) Int. Cl. H01M 50/367; H01M 50/383

(52) U.S. Cl. CPC H01M 50/367; H01M 50/383; H01M 2200/20

(57) ABSTRACT

Illustrative examples of an apparatus may include a quenching chamber configured to direct a heat flow from a battery cell compartment to a vent. The quenching chamber may be configured to extinguish a flame present in the heat flow before the heat flow reaches the vent. In other examples, a method includes receiving a heat flow from a battery cell compartment comprising a plurality of battery cells at a quenching chamber. The method further comprises directing the thermal runaway heat flow through the quenching chamber to a vent.

The present disclosure is directed to an apparatus for reducing temperature and/or pressure in a heat flow from a battery, and more particularly to an apparatus for reducing temperature and/or pressure in a heat flow from a battery in a stationary energy storage system.

### SUMMARY

In at least some example illustrations, an apparatus comprises a quenching chamber configured to direct a heat flow from a battery cell compartment to a vent. The quenching chamber may be configured to extinguish a flame present in the heat flow before the heat flow reaches the vent.

In at least some example apparatuses, a baffle is provided, which may be positioned within the quenching chamber.

In at least some of these example apparatuses, the baffle defines an undulating flow path through the quenching chamber. The undulating flow path may, in some examples, define a path length exceeding a distance from the battery cell compartment to the vent.

In at least some example apparatuses, a baffle includes a plurality of obstructions to the thermal runaway heat flow. In at least a subset of these examples, the quenching chamber is defined by a plurality of wall members, with the obstructions supported by a respective one of the wall members. The obstructions may define an oblique angle with the respective wall member.

In at least some example apparatuses, the vent is a pressure relief valve comprising a movable valve member. For example, the movable valve member may be configured to move in response to an internal pressure of the quenching chamber exceeding a threshold pressure.

In at least some example apparatuses, the quenching chamber is configured to dissipate one of a temperature and a pressure of the thermal runaway heat flow as the thermal runaway heat flow travels to the vent.

In at least some example apparatuses, the quenching chamber defines an enclosed volume configured to allow expansion of the thermal runaway heat flow.

The quenching chamber may, in at least some example apparatuses, comprise a plurality of flow paths from a corresponding plurality of battery cell compartment entry locations to the vent.

In at least some examples, the vent of an apparatus is configured to direct the thermal runaway heat flow to an external chamber of the apparatus, and the external chamber of the apparatus is configured to direct the thermal runaway heat flow out of the apparatus through an outlet.

Some example apparatuses may be a residential battery module comprising the battery cell compartment. In at least a subset of these examples, the apparatus comprises a battery chamber wall separating the battery cell compartment from an external chamber positioned above the battery cell compartment and the quenching chamber. In at least some of these examples, the vent may be positioned in the battery chamber wall, with the external chamber comprising an outlet positioned in a side wall of the external chamber.

In at least some example illustrations, a method comprises receiving a heat flow from a battery cell compartment comprising a plurality of battery cells at a quenching chamber. The method further comprises directing the thermal runaway heat flow through the quenching chamber to a vent. The quenching chamber may extinguish a flame present in the heat flow before the heat flow reaches the vent.

In at least some example methods, directing the heat flow through the quenching chamber includes passing the heat flow around a plurality of obstructions within the quenching chamber.

In at least some example methods, directing the heat flow through the quenching chamber includes passing the thermal runaway heat flow along an undulating path.

In at least some example methods, the vent is a pressure relief valve comprising a movable valve member, and the method further comprises venting the heat flow from the quenching chamber via the movable valve member in response to an internal pressure of the quenching chamber exceeding a threshold pressure.

### BRIEF DESCRIPTION OF THE DRAWINGS

The above and other features of the present disclosure, its nature and various advantages will be more apparent upon consideration of the following detailed description, taken in conjunction with the accompanying drawings in which:

FIG. 1 shows a cutaway view of an illustrative stationary energy storage system, e.g., for a residence, in accordance with some embodiments of the present disclosure;

FIG. 2A shows a perspective view of an illustrative pressure relief valve, in accordance with some embodiments of the present disclosure;

FIG. 2B shows a cross-sectional view of the pressure relief valve of FIG. 2A taken along line 2B-2B, in accordance with some embodiments of the present disclosure;

FIG. 3 shows a cutaway view of another example stationary energy storage system, e.g., for a residence, in accordance with some embodiments of the present disclosure;

FIG. 4A shows a cutaway view of another example stationary energy storage system, e.g., for a residence, in accordance with some embodiments of the present disclosure;

FIG. 4B shows an enlarged portion of the cutaway view of the stationary energy storage system of FIG. 4A, according to an example;

FIG. 4C shows a cutaway view of another stationary energy storage system, according to an example approach;

FIG. 4D shows a cutaway view of another stationary energy storage system, in accordance with some example approaches; and

FIG. 5 shows a flowchart of an illustrative process for treating a heat flow of a battery system, in accordance with some embodiments of the present disclosure.

### DETAILED DESCRIPTION

Battery systems have been developed to provide on-demand power in residential and commercial applications. Generally, battery cells of these stationary battery systems may selectively store and supply electrical energy, e.g., to a residence. Merely by way of example, one or more stationary battery systems may have a plurality of, and in some cases a large number, of battery cells. The battery cells are configured to store electrical energy received from a power grid and to provide electrical power from the battery cells on demand, e.g., while the power grid is unavailable, experiencing an outage, etc. In some applications, stationary electrical power storage systems facilitate deployment of alternative energy by allowing temporary storage of power generated by solar cells or panels, merely as one example.

Thermal runaway events may occur in battery cells, e.g., lithium-based battery cells such as lithium-ion (“Li-ion”), Lithium-Nickel-Manganese-Cobalt-Oxide (“NMC”), or Lithium Nickel-Cobalt-Aluminum Oxide (“NCA”) cells, which may be used in stationary power storage systems. In these thermal runaway events, elevated temperatures due to a battery fault, misuse, or thermal event may cause an operating temperature of one or more battery cells to increase rapidly. These thermal runaway events can result in excess heat, and in extreme cases can potentially cause property or other damage. Further, to the extent an electrical power storage system is installed or fixed at a given location such as in a stationary application, there is a need for the electrical power storage system to contain potential thermal runaway events, e.g., to prevent excess heat escaping the system. In an example, a lithium-ion battery cell may become gaseous at approximately 400 degrees Celsius, and as a result a battery system with one or more cells undergoing a thermal runaway event may become unstable. Moreover, autoignition temperatures of some gases typical of thermal runaway events in a lithium-ion cell may be as low as 450 degrees Celsius, and as a result any further escalation in temperatures can further destabilize the system, potentially causing damage to adjacent property. As used herein, a thermal runaway heat flow is defined as a gaseous emission from a battery cell resulting from the battery cell reaching a temperature sufficient to cause a chemical reaction within the battery cell, thereby creating the gaseous emission.

Accordingly, example illustrations disclosed herein generally employ an apparatus configured to contain a thermal runaway event within an electrical power storage system, such as a battery module for a residential or commercial application. Example approaches may employ one or more chambers or compartments which generally quench a thermal runaway heat flow from a battery module. A temperature and/or pressure of a heat flow received at the quenching chamber may be reduced as the heat flow is passed through the quenching chamber. Temperature and/or pressure of a heat flow may be reduced within the quenching chamber in any manner that is convenient. In some example approaches, a heat flow is allowed to expand within the quenching chamber, thereby reducing temperature and/or pressure of the heat flow within the chamber. In some examples, obstructions within the quenching chamber cause the heat flow to follow a circuitous or undulating path within the quenching chamber, thereby reducing temperature and/or pressure within the chamber. In some example approaches, a baffle may be present within the quenching chamber to facilitate reductions of temperature and/or pressure of heat flows through the quenching chamber. Accordingly, in the various example approaches, to the extent a flame may be present in a heat flow received at the quenching chamber, e.g., due to a thermal runaway or other event of the battery module, the flame may be extinguished before the heat flow reaches the vent.

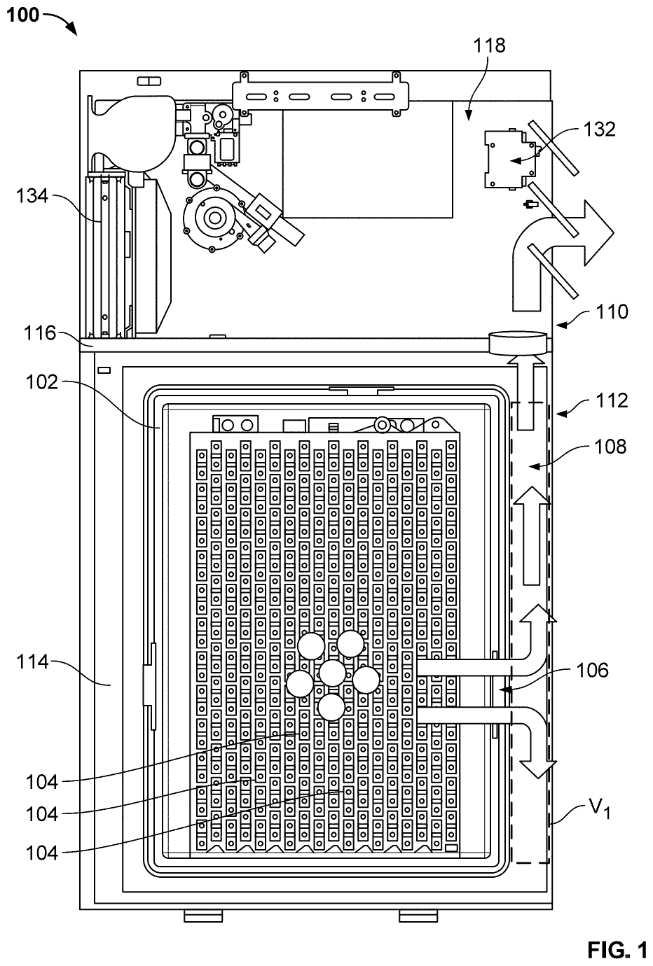

Turning now to FIG. 1, an example stationary power supply system 100 is illustrated. The system 100 may be employed as a residential power supply, e.g., for a residence, or in any other application that may be convenient. The system 100 includes a battery module 102 that generally provides power and energy, and which encloses a plurality of battery cells 104. The cells 104 may be any type that is convenient, e.g., 2170-type cylindrical lithium-ion cells. The cells 104 may be electrically connected or tied together in any manner that is convenient. In an example, the battery module 102 includes an upper sub-module and a lower sub-module, with each sub-module having of 432 cylindrical cells. Accordingly, in this example the battery module 104 includes total 864 cylindrical cells. The cells 104 may be arranged in a specific series-parallel combination to optimize energy density. In an example, the maximum energy throughput of the battery module 102 is 15.55 kilowatt hours (kWh), with a relatively reduced usable energy of 13.2 kWh to increase operational life of the battery module 102. The cells 104 are illustrated mounted such that each are aligned in a horizontal configuration with respect to the system 100 (such that a top of each cell 104 is visible in the side cutaway view of the system 100), however any other positioning or configuration of the cells 104 within the battery module 102 may be employed that is convenient. An insulating material, e.g., mica, may be provided around the battery module 102 or cells 104. In an example, the mica sheets are positioned such that they are spaced above and in between the sub-modules of the battery module 102, e.g., 20 mm above the top and bottom battery sub-modules. The mica sheets/material may generally prevent burn-through of internal components adjacent the battery module 102, e.g., a lid or other structure members of the system 100.

The system 100 may be installed or fixed in an installation position for storing electrical power, e.g., from a residential power grid, solar panel installation, or the like. The cells 104 may thus store electrical energy, which may be provided subsequently, e.g., during periods when the residential grid is unavailable. The system 100 includes supports 150 configured to allow the system 100 to rest upon a floor surface (not shown in FIG. 1). Alternatively, the system 100 may be mounted to a wall or otherwise suspended above a floor surface. The system 100 may generally be installed in the vertical orientation illustrated in FIG. 1, i.e., with a battery chamber 114 thereof positioned beneath an external chamber 118.

The battery module 102 may generally emit gases and/or heat flows from the cells 104, e.g., due to an increase in operating temperature and/or thermal events in one or more of the cells 104. An aperture 106 of the module 102 may be provided to permit heat flows caused by variation in pressure and/or temperature to escape the battery module 102 into an adjacent quenching chamber 108. In the example illustrated in FIG. 1, a single battery cell compartment entry location, i.e., the aperture 106, is provided for the module 102 that fluidly connects an interior of the module 102 with the quenching chamber 108. The aperture 106 is illustrated positioned along a rear wall of the module 102, although any other position may be employed that is convenient. Accordingly, the battery module 102 generally freely emits pressure/temperature flows into the quenching chamber 108.

The quenching chamber 108 is configured to direct heat flows from the battery cell compartment, i.e., module 102, to a vent 110. Generally, heat flows may enter the quenching chamber 108 and spread within the chamber 108. Pressure from the heat flow may build quickly, particularly for a runaway thermal event, and the buildup of pressure may force open a vent 110 of the quenching chamber 108. As will be described further below, the quenching chamber 108 may also include a baffle positioned within the quenching chamber 108 that is configured to facilitate reductions in temperature and/or pressure of a heat flow received within the quenching chamber 108 from the module 102. Further, to the extent a thermal runaway event may occur with respect to cell(s) 104 within the battery module 102, the heat flow may generally be suppressed by the quenching chamber 108. Accordingly, the quenching chamber 108 may generally reduce or dissipate one of a temperature or a pressure of the thermal runaway heat flow as the thermal runaway heat flow travels to the vent 110. In the example illustrated in FIG. 1, the quenching chamber 108 defines an enclosed volume V₁, which is configured to allow expansion of the heat flows from the battery module 102. Accordingly, gases of a heat flow may generally expand and cool inside the quenching chamber 108, and as a result contains or “quenches” the heat flow, preventing auto-ignition of gases or components of the system 100, at least beyond the enclosed volume Vi of the quenching chamber 108.

In an example, a temperature of a heat flow, such as a thermal runaway heat flow generated by cell(s) 104 of the module 102, may be reduced by a drop in pressure resulting from expansion of the heat flow into the quenching chamber 108. As will be described further below in other examples, a baffle may be present within the quenching chamber 108 to facilitate reductions in temperature and/or pressure of a heat flow.

Heat flow(s) treated within the quenching chamber 108 may be received at the vent 110. In the example illustrated in FIG. 1, gases from the heat flow may exit the quenching chamber 108 via a port 112 and into a surrounding chamber 114. The chamber 114 generally surrounds the battery module 102 and is defined in part by a battery chamber wall 116. The vent 110 thus permits excess pressure and/or heat to escape the chamber 114 into an external chamber 118 positioned above the battery module 102 and chamber 114. Upon exiting the quenching chamber 108, heat flow(s) may be substantially reduced in pressure and/or temperature as a result of the effect of the quenching chamber 108, as will be discussed further below. Nevertheless, the heat flow exiting the quenching chamber 108 may still have an elevated temperature and/or pressure relative to ambient air surrounding the system 100. Accordingly, an interior of the chamber 114 may have an elevated temperature and/or pressure as a result of the heat flow exiting the quenching chamber 108.

The vent 110 may be a pressure relief valve configured to permit venting from the chamber 114 upon the chamber 114 reaching a predetermined internal pressure. Accordingly, normal operation and/or expected operating temperature fluctuations may not cause the vent 110 to release pressure from the chamber 114. Further, the vent 110 may generally prohibit entry/intrusion of air from outside the chamber 114. If a thermal runaway event occurs that causes sufficient temperature and/or pressure to build within the battery module 102 and travel through the quenching chamber 108 and into the chamber 114 such that a threshold pressure of the vent 110 is reached, the vent 110 may open to permit release of the excess pressure from the chamber 114.

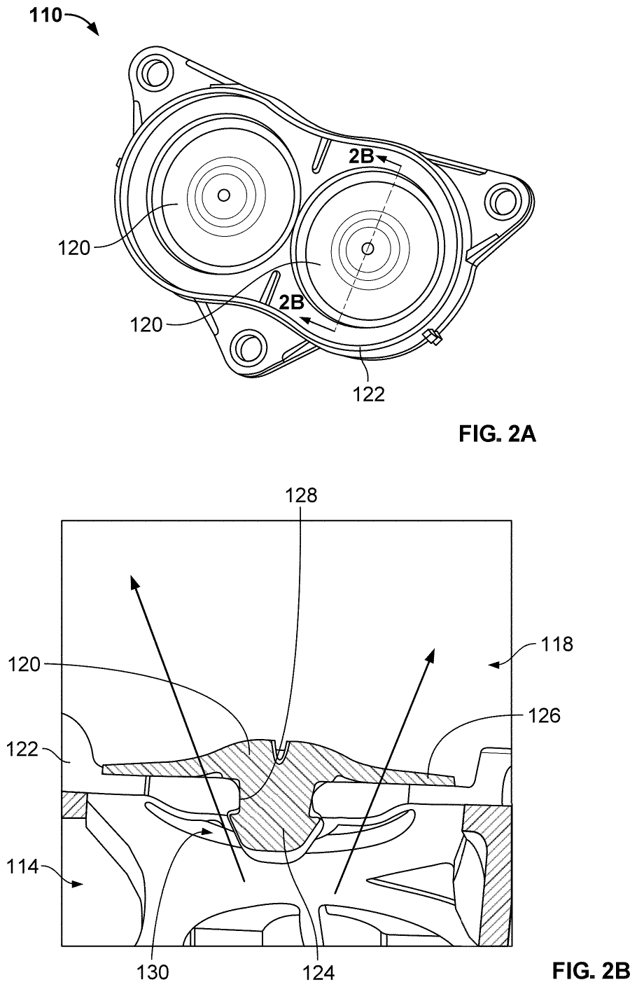

Referring now to FIG. 2A, an example vent 110 is illustrated and described in further detail. The vent 100 is illustrated with two movable valve members 120. The vent 110 is shown in FIG. 2B positioned in the battery chamber wall 116. Each of the movable valve members 120 may be configured to move in response to an internal pressure of the quenching chamber 108 exceeding a threshold pressure. For example, as noted above in the illustration of FIG. 1, the quenching chamber 108 may receive a thermal runaway heat flow from the battery module 102, which is quenched to reduce temperature and/or pressure, and then passed into the battery chamber 114. The resulting increase in pressure within the battery chamber 114 may cause the moveable valve member 120 to deflect, venting excess pressure into the external chamber 118. The moveable valve member 120 may move relative to a valve support 122 fixed in an aperture of the battery chamber wall 116. As best seen in FIG. 2B, the moveable valve member 120 may be an umbrella-style valve comprising a stem 124 and a moveable umbrella 126. The stem 124 is received in a central aperture 128 of the valve support 122, and the umbrella 126 extends radially from the stem 124 to cover an aperture 130 in the valve support 122. Deflection of the umbrella 126, e.g., in response to an excess pressure within the battery chamber 114, may deflect the umbrella 126 and permit venting into the external chamber 118. The umbrella 126 may be configured to remain closed so long as pressure within the battery chamber 114 does not exceed a predetermined or desired threshold pressure. In an example, the umbrella 126 is relatively permissive and is configured to remain closed until pressure within the battery chamber 114 reaches 0.14 pounds per square inch (psi), although it is expected that substantially greater pressures may be present within the battery chamber 114 during a thermal runaway. The moveable valve member 120 may also be a one-way valve as illustrated in FIG. 2, i.e., such that fluid ingress from the external chamber 118 into the battery chamber 114 is generally prevented.

Referring again to FIG. 1, as noted above excess pressure may flow through the vent 110 into the external chamber 118, e.g., upon the battery chamber 114 and/or quenching chamber 108 reaching a threshold pressure. The external chamber 118 of the apparatus is configured to direct heat flows out of the system 100 through an outlet 132. Generally, the external chamber 118 may provide a vented enclosure for electronics of the system 100, e.g., controllers, processors, or the like. The external chamber 118 also includes a fan 134. The fan 134 may be operated to facilitate exhaust or cooling of the external chamber 118, components within the external chamber 118, or other components of the system 100.

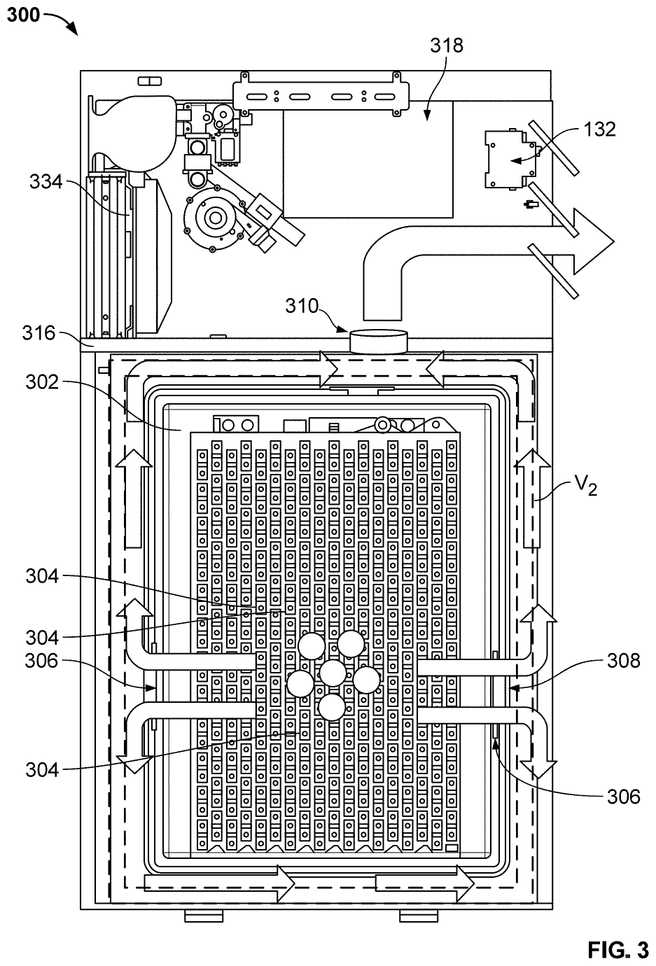

The system 100 is illustrated as having a single flow path from a single battery cell compartment entry location, i.e., the aperture 106, of the battery module 102 to the vent 110. Turning now to FIG. 3, in another example stationary power supply system 300, multiple flow paths are provided from battery module 302 to vent 310. More specifically, two battery cell compartment entry locations are provided by apertures 306 on opposite sides of the battery module 302. Quenching chamber 308 extends around an entire periphery of the battery module 302. Accordingly, heat flows from the battery module 302 to the vent 310 may travel along multiple flow paths, e.g., corresponding to the paths from the apertures 306 to the vent 310, respectively.

As with the system 100, the quenching chamber 308 of system 300 is configured to direct heat flows from the battery cell compartment, i.e., module 302, to vent 310. As will be described further below, the quenching chamber 308 may also include a baffle positioned therein, with the baffle configured to facilitate reductions in temperature and/or pressure of a heat flow received within the quenching chamber 308 from the module 302. Further, to the extent a thermal runaway event may occur with respect to cell(s) 304 within the battery module 302, the heat flow may generally be suppressed by the quenching chamber 308. Accordingly, as with quenching chamber 108 of system 100, the quenching chamber 308 of system 300 may generally reduce or dissipate one of a temperature or a pressure of the thermal runaway heat flow as the thermal runaway heat flow travels to the vent 310. In the example illustrated in FIG. 3, the quenching chamber 308 defines an enclosed volume V₂, which is configured to allow expansion of the heat flows from the battery module 302. The volume V₂ extends about a periphery of the battery module 302. In an example, a temperature of a heat flow, such as a thermal runaway heat flow generated by cell(s) 304 of the module 302, may be reduced by a drop in pressure resulting from expansion of the heat flow into the quenching chamber 308. As will be described further below in other examples, a baffle may be present within the quenching chamber 308 to facilitate reductions in temperature and/or pressure of a heat flow.

Heat flow(s) treated within the quenching chamber 308 may be received at the vent 310. Generally, pressure may build up within the quenching chamber 308 as heat flow enters the quenching chamber 308 from the battery module 302 through each of the apertures 306, eventually reaching a threshold pressure of the vent 310, thereby opening the vent 310. The quenching chamber 308 may substantially reduce pressure and/or temperature of heat flows passed from the battery module 302 as a result of the effect of the quenching chamber 308. For example, to any extent flames may propagate in a heat flow exiting the apertures 306, e.g., as a result of gases reaching autoignition temperature(s), temperatures are reduced and flames are generally extinguished before the heat flow reaches the vent 310. In the example illustrated in FIG. 3, the volume V₂ of the quenching chamber 308 is defined in part by chamber wall 316. Gases from the heat flow may exit the quenching chamber 308 via the vent 310 and be passed into external chamber 318. The vent 310 may, as with vent 310 of the system 100, be a pressure relief valve such as illustrated in FIG. 2. The vent 310 may be configured to vent excess pressure through the vent 310 into the external chamber 318, e.g., upon the quenching chamber 308 reaching a threshold pressure. The threshold pressure may correspond to a relatively low pressure in comparison to a thermal runaway event of the battery module 302, e.g., such that the vent 310 deflects when the pressure within the quenching chamber 308 reaches 0.14 psi, as compared with the relatively higher pressures typical of a thermal runaway event, which may reach 10 kPa in some examples. The external chamber 318 of the apparatus is configured to direct heat flows out of the system 300 through an outlet 332. Generally, the external chamber 318 may provide a vented enclosure for electronics of the system 300, e.g., controllers, processors, or the like. The external chamber 318 also includes a fan 334. The fan 334 may be operated to facilitate exhaust or cooling of the external chamber 318 or other components of the system 300.

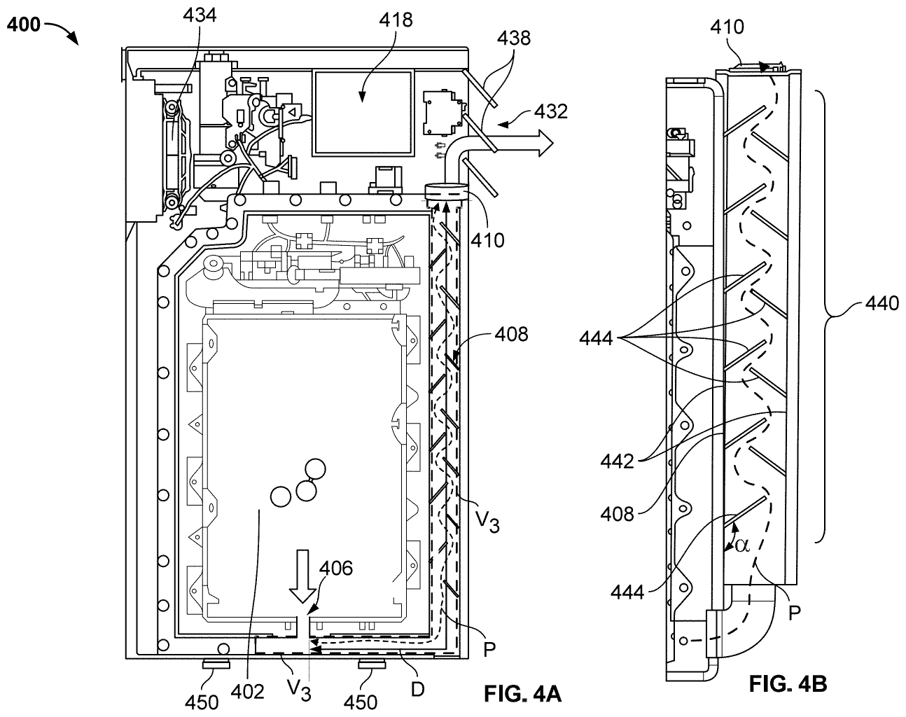

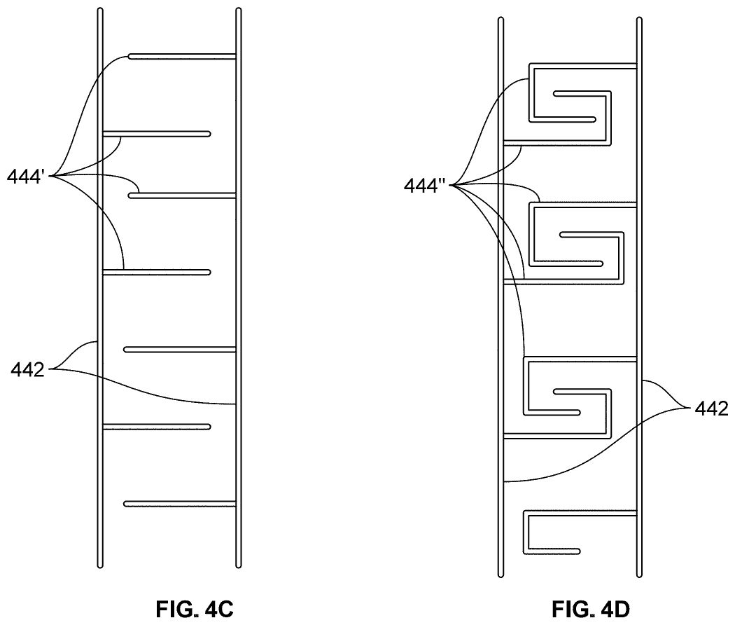

As noted above, quenching chambers 108 and 308 of the systems 100 and 300, respectively, may include baffles configured to facilitate reductions in temperature and/or pressure of a heat flow passing through the quenching chambers 108/308. Turning now to FIGS. 4A and 4B, an example baffle is illustrated and described in further detail in the context of another example stationary energy storage system 400. The system 400 may be employed as a residential power supply, e.g., for a residence, or in any other application that may be convenient.

The system 400, as with systems 100 and 300 described above, includes a battery module 402 that encloses a plurality of battery cells 404, e.g., 2170-type cylindrical lithium-ion cells. The cells 404 may be electrically connected or tied together, and mounted such that each are aligned in a horizontal configuration with respect to the system 400, although any other positioning or configuration of the cells 404 within the battery module 402 may be employed that is convenient.

The system 400 is installed or fixed in an installation position for storing electrical power, e.g., from a residential power grid, solar panel installation, or the like. The cells 404 may thus store electrical energy, which may be provided subsequently, e.g., during periods when the residential grid is unavailable. The system 400 includes supports 450 configured to allow the system 400 to rest upon a floor surface (not shown in FIGS. 4A and 4B), with the system 400 in a vertical orientation, i.e., with battery module 402 positioned beneath an external chamber 418.

The battery module 402 may generally emit gases and/or heat flows from the cells 404, e.g., due to an increase in operating temperature and/or thermal events in one or more of the cells 404. An aperture 406 of the module 402 is illustrated, which generally permits heat flows caused by variation in pressure and/or temperature to escape the battery module 402 into the adjacent quenching chamber 408. In the example illustrated in FIGS. 4A and 4B, a single aperture 406 is provided for the module 402 fluidly connecting an interior of the module 402 with the quenching chamber 408. The aperture 406 is illustrated positioned along a lower wall of the module 402, although any other position may be employed that is convenient. Accordingly, the battery module 402 generally freely emits pressure/temperature flows into the quenching chamber 408.

The quenching chamber 408 is configured to direct heat flows from the battery cell compartment, i.e., module 402, to a vent 410. The quenching chamber 408, as noted above, may also include a baffle positioned within the quenching chamber 408, as will be discussed further below. More specifically, as seen in FIG. 4B, a baffle may be formed by a plurality of obstructions or flow diverting members 444, as will be discussed further below. Reductions in temperature and/or pressure of a heat flow received within the quenching chamber 408 from the module 402 may occur as a result of the extended distance the heat flow travels from the aperture 406 to the vent 410, similar to the effect provided by the quenching chambers 108/308 of systems 100/300 described above. Accordingly, the quenching chamber 408 may generally reduce or dissipate one of a temperature or a pressure of the thermal runaway heat flow as the thermal runaway heat flow travels to the vent 410. In the example illustrated in FIGS. 4A and 4B, the quenching chamber 408 defines an enclosed volume V₃, which is configured to allow expansion of the heat flows from the battery module 402. In an example, a temperature of a heat flow, such as a thermal runaway heat flow generated by cell(s) 404 of the module 402, may be reduced by a drop in pressure resulting from expansion of the heat flow into the quenching chamber 408. Additionally, the baffle 440 may further enhance dissipation of temperature and/or pressure of the heat flow traveling through the quenching chamber 408. Accordingly, to the extent a thermal runaway event may occur with respect to cell(s) 404 within the battery module 402, the heat flow may generally be suppressed by the quenching chamber 408.

As best seen in the enlarged view of FIG. 4B, the flow diverting members 444 may generally define an undulating flow path through the quenching chamber 408. The undulations of the flow path may generally increase a distance traveled by the heat flow from the aperture 406 to the vent 410 (as compared with a straight-line distance D from the aperture 406 to the vent 410), represented in FIGS. 4A and 4B as path length P. Accordingly, the path length P of the heat flow through the quenching chamber 408 may exceed a distance D from the battery cell module 402 to the vent 410. In an example, the path length P is substantially greater than the distance D. In a further example, the path length P is at least twice the distance D. Generally, it is desired that sufficient volume or space is provided within the quenching chamber 408 to facilitate quenching of flames present in heat flow(s) circulating through the quenching chamber 408. In an example, the volume V₃ is at least as great as a volume of gases vented out of the cells 104 experiencing a thermal runaway.

An example baffle may include a plurality of flow diversions or obstructions to the thermal runaway heat flow passing through the quenching chamber 408. In the example illustrated in FIGS. 4A and 4B, the quenching chamber 408 is defined by a plurality of wall members 442 forming an enclosed volume V₃ of the quenching chamber 408. One or more baffles 440 may be provided within the quenching chamber 408. In the example illustrated, a baffle 440 is defined by plurality of obstructions or flow diverting members 444 that are positioned relatively closely together within the quenching chamber 408 so that a heat flow through the quenching chamber 408 is forced through a relatively longer flow path. In other example approaches, multiple baffles may be provided, e.g., with multiple groups of relatively closely spaced obstructions 444 separated by a volume that is relatively free of obstructions. In the example illustrated in FIGS. 4A and 4B, each of the obstructions 444 extend from the wall members 442, such that the obstructions 444 generally divert flow of the heat flows passing through the quenching chamber 408. For example, the obstructions 444 each force a heat flow passing through the quenching chamber 408 into a plurality of flow reversals or undulations as the heat flow travels toward the vent 410. As best seen in FIG. 4B, each of the obstructions 444 may define an oblique angle a with its respective wall member 442. In other examples, the angle a may be perpendicular. For example, referring now to FIG. 4C, obstructions 444′ are illustrated extending in a perpendicular direction with respect to the wall members 442. Moreover, any other configuration of a flow diverting member or obstruction may be employed that is convenient. In the examples illustrated in FIGS. 4B and 4C, the obstructions 444/444′ are generally planar members which are supported at a single end thereof by the wall members 442. However, obstructions may in other approaches be supported at both ends by opposing wall members, with an aperture or opening defined by the obstruction. In still another example illustrated in FIG. 4D, obstructions 444″ themselves are angled and cooperate with adjacent obstructions 444″ to generally define a serpentine path for a heat flow(s).

Generally, a heat flow(s) is passed through the quenching chamber 408 to the vent 410. In the example illustrated in FIGS. 4A and 4B, gases from the heat flow may exit the quenching chamber 408 via vent 410. Upon exiting the quenching chamber 408, heat flow(s) may be substantially reduced in pressure and/or temperature as a result of the effect of the quenching chamber 408 and/or baffle 440. Nevertheless, the heat flow exiting the quenching chamber 408 may still have an elevated temperature and/or pressure relative to ambient air surrounding the system 400. Accordingly, the heat flow exiting the quenching chamber 408 may still have a relatively elevated temperature and/or pressure.

As with vents 110 and 310 described above, the vent 410 may be a pressure relief valve configured to permit venting from the quenching chamber 408 upon the chamber 408 reaching a predetermined internal pressure. Accordingly, normal operation and/or expected operating temperature fluctuations may not cause the vent 410 to release pressure from the quenching chamber 408. Further, the vent 410 may generally prohibit entry/intrusion of air from outside the quenching chamber 408. If a thermal runaway event occurs that causes sufficient temperature and/or pressure to build within the battery module 402 and travel through the quenching chamber 408 such that a threshold pressure of the vent 410 is reached, the vent 410 may open to permit release of the excess pressure. The vent 410 may be a pressure relief valve comprising a movable valve member, e.g., as illustrated and described above in FIG. 2. Accordingly, excess pressure may flow through the vent 410 into the external chamber 418, e.g., upon the quenching chamber 408 reaching a threshold pressure. The external chamber 418 of the apparatus is generally configured to direct heat flows out of the system 400 through an outlet 432. More specifically, fins 438 are provided which direct heat flows generally downward as they exit the system 400 via the outlet 432. Generally, the external chamber 418 may provide a vented enclosure for electronics of the system 400, e.g., controllers, processors, or the like. The external chamber 418 also includes a fan 434. The fan 434 may be operated to facilitate exhaust or cooling of the external chamber 418 or other components of the system 400.

The quenching chambers 108, 308, and 408 may each generally prevent auto-ignition of gases therein resulting from a thermal runaway heat flow. In an example, a thermal runaway heat flow may be quenched such that, to any extent an autoignition temperature of typical gases included in a lithium cell thermal emission is reached within the quenching chamber 108/308/408, any resulting flames are kept within the quenching chamber 108/308/408. In other words, flames are extinguished by the time the heat flow reaches the vent 110/310/410, preventing damage outside the system 100/300/400, respectively. More specifically, gases typically included in a thermal emission from battery cells 104/304/404 may include one or more of the following gases, with respective auto-ignition temperatures listed below:

TABLE 1

| | Autoignition |
|---|---|
| | temperature |
| Gas | (degrees Celsius) |
| Carbon monoxide (CO) | 609 |
| Hydrogen (H₂) | 585 |
| Methane (CH₄) | 537 |
| Ethane (C₂H₆) | 472 |
| Ethylene (C₂H₄) | 450 |

In an example illustration, temperatures measured at the vents 110, 310, and 410 of the quenching chambers 108/308/408 within three seconds of a thermal runaway event failed to reach 450 degrees. As a result, the quenching chambers 108/308/408 each contained thermal runaway heat flows within the quenching chambers, thereby preventing damage outside their respective systems 100/300/400. Furthermore, quenching chambers using a baffle, e.g., baffle 440, have been found to be even more effective at quenching a thermal runaway event. In one example, the baffle 440 was found to be 26% more effective compared with a quenching chamber without the baffle 330. More specifically, the addition of the baffle 440 increases volume that must be consumed or traveled by a heat flow through the quenching chamber, and increases the time needed for gasses of the heat flow to flow around obstructions, thereby reducing temperature of the heat flow(s) at the outlet or vent 410. It should also be noted that the example systems 100, 300, and 400 described above each generally have different volumes for their respective quenching chambers 108, 308, and 408. For example, the volume V₂ of the quenching chamber 308 illustrated in FIG. 3 is relatively larger than the volume V₁ of the quenching chamber 108 illustrated in FIG. 1. Accordingly, the quenching chamber 308 may generally provide a greater volume/space for a heat flow from a battery chamber, thereby providing additional capability to quench flames in the heat flow. Example quenching chambers may be configured with an appropriate volume or space and with or without a baffle within the quenching chamber, depending on requirements for a given application.

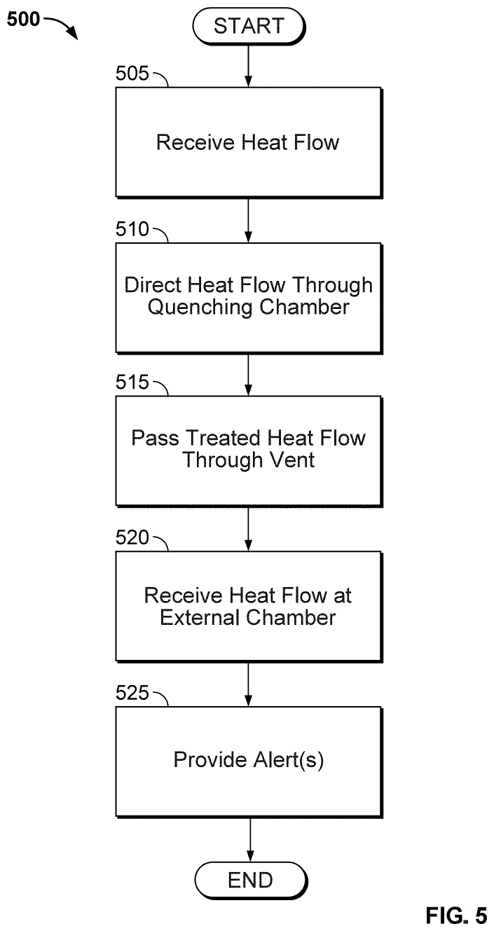

Turning now to FIG. 5, an example process 500 of managing a heat flow from a battery is illustrated. Process 500 may begin at block 505, where a thermal runaway heat flow from a battery cell compartment comprising a plurality of battery cells is received at a quenching chamber. For example, as discussed above, a thermal runaway heat flow in example systems 100, 300, and 400 may be generated by one or more cells 104/304/404, respectively. The heat flows may be conducted to a quenching chamber 108/308/408. Process 500 may then proceed to block 510.

At block 510, the thermal runaway heat flow may be directed through the quenching chamber to a vent. As discussed above, example quenching chambers 108, 308, and/or 408 may generally provide a volume for expansion and cooling of a heat flow. Further, a baffle of the quenching chambers 108, 308, and/or 408 may include obstructions and/or force a heat flow traveling through the quenching chambers along an undulating path, further enhancing the degree to which the quenching chamber may suppress temperature and/or pressure of the heat flow.

Proceeding to block 515, the treated heat flow may be conducted from the quenching chamber to a vent. For example, as discussed above vents 110, 310, and/or 410 may be a pressure relief valve configured to respond to an internal pressure of the exceeding a threshold pressure, thereby allowing the treated heat flow to pass through the vent upon the threshold pressure being reached. Further, example pressure relief valves may employ a movable valve member, e.g., as illustrated in FIGS. 2A and 2B and described above. While the heat flow may have an elevated temperature and/or pressure relative to ambient conditions of the systems 100, 300, and 400, the quenching chambers 108, 308, and 408 may each prevent the spread of the thermal runaway event by reducing or preventing entirely autoignition of gases within the systems 100, 300, and 400. More specifically, as noted above gases of a heat flow may generally expand and cool inside the quenching chambers 108, 308, and 408, and as a result the heat flow is contained to prevent auto-ignition of gases or components of the systems 100, 300, and 400. Process 500 may then proceed to block 520.

At block 520, the thermal runaway heat flow may be received from the vent at an external chamber of the apparatus. For example, as described above an external chamber 118, 318, and 418 of systems 100, 300, and 400 may each generally receive a heat flow via the vents 110, 310, and 410, respectively. Further, the heat flows may be conducted out of the external chamber and the systems 100, 300, and 400 via respective outlets 132, 332, and 432. The vents 110, 310, and 410 may be positioned in a battery chamber wall, e.g., walls 116, 316, and 418, respectively, which separates a battery cell compartment from the external chamber. While the heat flow may be visible, e.g., from smoke particles, or noticeable from additional heat, potential harm to adjacent property may be reduced or eliminated as a result of the quenching of the heat flow within the quenching chambers 108, 308, 408. Moreover, to the extent gases emitted by battery cells may reach autoignition temperature, or that flames may otherwise result during a thermal runaway event within the systems 100, 300, or 400, the example quenching chambers generally prevent flame or combustion from occurring outside the quenching chambers.

Proceeding to block 525, an alert may be optionally generated of the thermal runaway event. For example, systems 100, 300, and/or 400 may each include temperature and/or pressure sensors within their respective battery module and/or quenching chambers. Controllers of the systems 100, 300, and/or 400 may communicate an alert, e.g., via an alarm of the systems 100, 300, and/or 400. Alternatively or in addition, to the extent the systems 100, 300, and 400 may communicate with a central office or mobile device, e.g., via a WiFi network, Bluetooth, or the like, the system 100, 300, and/or 400 may provide an alert of the thermal runaway event. Process 500 may then terminate.

The foregoing description includes exemplary embodiments in accordance with the present disclosure. These examples are provided for purposes of illustration only, and not for purposes of limitation. It will be understood that the present disclosure may be implemented in forms different from those explicitly described and depicted herein and that various modifications, optimizations, and variations may be implemented by a person of ordinary skill in the present art, consistent with the following claims.

What is claimed is:

1. An apparatus, comprising:
a quenching chamber configured to direct a heat flow from a battery cell compartment to a vent, the quenching chamber configured to extinguish a flame present in the heat flow before the heat flow reaches the vent.

2. The apparatus of claim 1, further comprising one or more baffles positioned within the quenching chamber.

3. The apparatus of claim 1, wherein the one or more baffles define an undulating flow path through the quenching chamber.

4. The apparatus of claim 3, wherein the undulating flow path defines a path length exceeding a distance from the battery cell compartment to the vent, the path length being at least twice as great as the distance.

5. The apparatus of claim 1, wherein the one or more baffles include a plurality of obstructions to the thermal runaway heat flow.

6. The apparatus of claim 5, wherein the quenching chamber is defined by a plurality of wall members, and the plurality of obstructions are supported by one of the wall members, each of the obstructions defining an oblique angle with the wall member of the obstruction.

7. The apparatus of claim 1, wherein the vent is a pressure relief valve comprising a movable valve member configured to move in response to an internal pressure of the quenching chamber exceeding a threshold pressure.

8. The apparatus of claim 1, wherein the quenching chamber is configured to dissipate one of a temperature and a pressure of the thermal runaway heat flow as the thermal runaway heat flow travels to the vent.

9. The apparatus of claim 1, wherein the quenching chamber defines an enclosed volume configured to allow expansion of the thermal runaway heat flow.

10. The apparatus of claim 1, wherein the quenching chamber comprises a plurality of flow paths from a corresponding plurality of battery cell compartment entry locations to the vent.

11. The apparatus of claim 1, wherein the vent is configured to direct the thermal runaway heat flow to an external chamber of the apparatus, the external chamber of the apparatus configured to direct the thermal runaway heat flow out of the apparatus through an outlet.

12. The apparatus of claim 1, wherein the apparatus is a residential battery module comprising the battery cell compartment.

13. The apparatus of claim 12, further comprising a battery chamber wall separating the battery cell compartment from an external chamber positioned above the battery cell compartment and the quenching chamber.

14. The apparatus of claim 13, wherein:
the vent is positioned in the battery chamber wall; and
the external chamber comprises an outlet positioned in a side wall of the external chamber.

15. A residential battery module, comprising:
a battery module enclosed within a battery cell compartment, the battery module comprising one or more battery cells configured to store electrical energy;
a quenching chamber configured to direct a heat flow from the battery cell compartment to a vent, the quenching chamber configured to extinguish a flame present in the heat flow before the heat flow reaches the vent; and
a battery chamber wall separating the battery cell compartment from an external chamber positioned above the battery cell compartment and the quenching chamber, the vent positioned in the battery chamber wall, and the external chamber defining an outlet for the thermal runaway heat flow.

16. The residential battery module of claim 15, further comprising one or more baffles positioned within the quenching chamber, the one or more baffles including a plurality of obstructions to the thermal runaway heat flow.

17. A method, comprising:
receiving a heat flow from a battery cell compartment comprising a plurality of battery cells at a quenching chamber; and
directing the heat flow through the quenching chamber to a vent, the quenching chamber extinguishing a flame present in the heat flow before the heat flow reaches the vent.

18. The method of claim 17, wherein directing the thermal runaway heat flow through the quenching chamber includes passing the thermal runaway heat flow through one or more baffles within the quenching chamber, the one or more baffles comprising a plurality of obstructions.

19. The method of claim 17, wherein directing the thermal runaway heat flow through the quenching chamber includes passing the thermal runaway heat flow through an undulating flow path.

20. The method of claim 17, wherein the vent is a pressure relief valve comprising a movable valve member, the method further comprising venting the heat flow from the quenching chamber via the movable valve member in response to an internal pressure of the quenching chamber exceeding a threshold pressure.
